(19) United States
(12) Patent Application Publication
(10) Pub. No.: US 2026/0045636 A1
(43) Pub. Date: Feb. 12, 2026

(54) METHOD OF PREPARING POROUS SUBSTRATE OF SEPARATOR FOR RECHARGEABLE LITHIUM BATTERY, POROUS SUBSTRATE PREPARED USING THE SAME, SEPARATOR FOR RECHARGEABLE LITHIUM BATTERY INCLUDING THE SAME AND RECHARGEABLE LITHIUM BATTERY INCLUDING THE SAME

(71) Applicant: SAMSUNG SDI CO., LTD., Yongin-si (KR)

(72) Inventors: Sang Ho LEE, Suwon-si (KR); Sang Hyun PARK, Suwon-si (KR)

(73) Assignee: SAMSUNG SDI CO., LTD., Yongin-si (KR)

(21) Appl. No.: 19/292,171

(22) Filed: Aug. 6, 2025

(30) Foreign Application Priority Data
Aug. 6, 2024 (KR) 10-2024-0104600

(51) Int. Cl. H01M 50/403; H01M 10/42; H01M 50/417; H01M 50/489

(52) U.S. Cl. CPC H01M 50/403; H01M 10/4235; H01M 50/417; H01M 50/489

(57) ABSTRACT

The present disclosure relates to a method of preparing a porous substrate of a separator for a rechargeable lithium battery, a porous substrate prepared using the method, a separator for a rechargeable lithium battery including the porous substrate, and a rechargeable lithium battery including the porous substrate. The method of preparing a porous substrate of a separator for a rechargeable lithium battery includes stretching an unstretched film including a resin, wherein the resin includes a resin having a weight average molecular weight (MW) of about 1 million or less, the stretching includes multi-stage stretching, and the total stretching ratio is about 150 times or more.

### CROSS-REFERENCE TO RELATED APPLICATION

The present application claims priority to Korean Patent Application No. 10-2024-0104600, filed on Aug. 6, 2024 in the Korean Intellectual Property Office, the entire disclosure of which is incorporated herein by reference.

### BACKGROUND

### 1. Field of the Disclosure

The present disclosure relates to a method of preparing a porous substrate of a separator for a rechargeable lithium battery, a porous substrate prepared using the method, a separator for a rechargeable lithium battery including the porous substrate, and a rechargeable lithium battery including the porous substrate.

### 2. Discussion of Related Art

With increasing presence of electronic devices that use batteries, such as, e.g., mobile phones, notebook computers, electric vehicles, and the like, the demand for high energy density and high capacity rechargeable batteries is rapidly increasing. Accordingly, research and development to improve the performance of rechargeable lithium batteries is being actively conducted.

A rechargeable lithium battery includes positive and negative electrodes that include active materials capable of intercalating and deintercalating lithium ions, and an electrolyte, and produces electrical energy through oxidation and reduction reactions when lithium ions are intercalated and deintercalated into/from the positive and negative electrodes.

Due to the demand for high capacity and high output rechargeable lithium batteries, thin separators may be advantageous. Separators may provide high strength to enhance battery safety, such as reducing or preventing short circuits and ensuring impact safety during the battery assembly process.

Conventionally, polyethylene-based resin having a weight average molecular weight exceeding 1 million was used as the porous substrate material of a separator. This is because the polyethylene-based resin can provide high strength. However, the polyethylene-based resin is typically difficult to knead before extrusion and has a relatively long heat setting time, which may reduce processability and productivity. In addition, the porous substrate manufactured from the polyethylene-based resin exhibits a trade-off characteristic for the strength improvement due to an increase in the shutdown temperature, an increase in the melt shrinkage rate, and an increase in the thermal shrinkage rate due to an increase in the residual stress remaining during stretching and heat setting.

### SUMMARY

One example embodiment includes a method of preparing a porous substrate of a separator for a rechargeable lithium battery with improved productivity and processability using a resin having a weight average molecular weight of about 1 million or less.

Another example embodiment includes a method of preparing a porous substrate of a separator for a rechargeable lithium battery, which provides desired or improved mechanical strength and has improved melt shrinkage rate, shutdown temperature and thermal shrinkage rate, which are in a trade-off relationship with the mechanical strength.

Still another example embodiment includes a porous substrate of a separator for a rechargeable lithium battery prepared by the preparation method, a separator for a rechargeable lithium battery including the porous substrate, and a rechargeable lithium battery including the separator for a rechargeable lithium battery.

One example embodiment includes a method of preparing a porous substrate of a separator for a rechargeable lithium battery, the method including stretching an unstretched film including a resin, wherein the resin includes a resin having a weight average molecular weight (MW) of about 1 million or less, the stretching includes multi-stage stretching, and the total stretching ratio is about 150 times or more.

Another example embodiment includes a porous substrate prepared by the above-discussed preparation method.

Still another example embodiment includes a separator for a rechargeable lithium battery including the above-discussed porous substrate.

Yet another example embodiment includes a rechargeable lithium battery including a positive electrode, a negative electrode, and a separator for a rechargeable lithium battery located between the positive electrode and the negative electrode.

The method of preparing a porous substrate according to one example embodiment of the present disclosure includes a porous substrate which has desired or improved productivity and processability, and improved mechanical strength, melt shrinkage ratio, shutdown temperature, and heat shrinkage ratio, which are in a trade-off relationship with each other. Therefore, the method of preparing a porous substrate according to one example embodiment can reduce or suppress a short circuit of a rechargeable lithium battery, and enhance the safety of the rechargeable lithium battery, such as impact characteristics and vent characteristics.

### BRIEF DESCRIPTION OF THE DRAWINGS

The above and other objects, features and advantages of the present disclosure are more apparent to those of ordinary skill in the art by describing example embodiments thereof in detail with reference to the accompanying drawings, in which:

FIGS. 1 to 4 are cross-sectional views schematically illustrating a rechargeable lithium battery according to various example embodiments.

FIG. 5 is a flow chart illustrating a method of preparing a porous substrate of a separator for a rechargeable lithium battery, according to an example embodiment.

### DETAILED DESCRIPTION

Hereinafter, example embodiments of the present disclosure are described in detail. However, the embodiments are presented as examples, the present disclosure is not limited thereby, and the present disclosure is only defined by the scope of the claims to be described below.

Unless otherwise specified herein, when a part such as a layer, film, region, plate, and the like, is described as being “on” another part, the term “on” includes not only the case where the part is “directly on” the other part, but also the case where there is another part therebetween.

Unless otherwise specified in this specification, anything indicated in the singular may also include the plural. Further, unless otherwise stated, “A or B” may indicate “including A, including B, or including A and B.”

As used herein, the term “a combination thereof” may indicate a mixture, laminate, composite, copolymer, alloy, blend, and reaction product of the components.

Unless otherwise defined in this specification, a particle diameter may be an average particle diameter. Also, the term “particle diameter” refers to the average particle diameter (D50), which indicates the diameter of particles with a cumulative volume of 50% by volume in the particle size distribution. The average particle diameter (D50) may be measured by methods known to those skilled in the art, for example, by a particle size analyzer, a transmission electron micrograph, or a scanning electron micrograph. In another example method, an average particle diameter D50 value may be obtained by measuring the particle diameter using a measuring device using dynamic light scattering, performing data analysis to count the number of particles for each particle size range, and then calculating the particle diameter therefrom. Alternatively, D50 may be measured using laser diffraction. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the average particle diameter (D50) based on 50% of the particle diameter distribution in the measurement device may be calculated.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

In this specification, the term “polyolefin-based porous substrate” refers to a porous substrate containing a polyolefin as a main component, and for example, refers to a porous substrate including a polyolefin in an amount of about 90 wt % or more based on the total amount of the porous substrate.

### Method of Preparing Porous Substrate

A method of preparing a porous substrate according to one example embodiment includes stretching an unstretched film including a resin, wherein the resin includes a resin having a weight average molecular weight (MW) of about 1 million or less, the stretching includes multi-stage stretching, and the total stretching ratio is about 150 times or more.

The preparation method aims to provide a porous substrate, wherein the porous substrate includes a resin, for example, polyethylene, having a weight average molecular weight of about 1 million or less, and the porous substrate may have a thickness of about 10 μm or less, a ratio of puncture strength to thickness of about 75 gf/μm or more, an air permeability of about 120 sec/100 cc or less, a thermal shrinkage rate in each of the MD and TD of about 4.5% or less, a melt shrinkage rate in each of the MD and TD of about-5.0% or more, and a shutdown temperature of about 143° C. or lower.

The preparation method aims to prepare a polyolefin-based porous substrate.

The thickness of the porous substrate may be about 10 μm or less, for example, in a range of about 1 μm to 10 μm, thereby providing a separator thinning effect.

When the ratio of the puncture strength to the thickness of the porous substrate is about 75 gf/μm or more, for example, in a range of about 75 gf/μm to 100 gf/μm, the porous substrate has high mechanical strength even with a thin thickness, so that it can readily improve short-circuit defects and impact characteristics.

The porous substrate may have an air permeability of about 120 sec/100 cc or less, for example, in a range of about 50 sec/100 cc to 120 sec/100 cc. In the above range, the movement of lithium ions may be facilitated.

The porous substrate may have a thermal shrinkage rate of about 4.5% or less, for example, in a range of about 1% to about 4.5%, in each of the machine direction (MD) and transverse direction (TD). In the above range, the thermal shrinkage rate of the separator may be reduced, thereby improving the reliability of the battery.

The porous substrate may have a melt shrinkage age of about −5.0% or more, for example, in a range of about −5.0% to −2.0%, in each of the MD and TD.

Herein, the term “melt shrinkage ratio” refers to the shrinkage force of the porous substrate when the porous substrate is shut down and melted during a high-temperature abnormal reaction of a rechargeable lithium battery. In the above range, a separator having desired or improved heat resistance may be obtained, and when a battery is manufactured using the porous substrate, there may be an advantage in that the separator can withstand a considerable temperature without melting even when the battery is overheated during use, thereby reducing or preventing an electrode short circuit or battery explosion.

The porous substrate may have a shutdown temperature of about 143° C. or lower, for example, in a range of about 140° C. to about 143° C. In the above range, the reliability of the battery may be improved when thermal runaway occurs in the battery.

Therefore, the porous substrate may be used as a substrate of a separator for a rechargeable lithium battery to improve the short-circuit defects and impact characteristics of the battery and increase the reliability of the battery.

In the preparation method, a resin having a weight average molecular weight of about 1 million or less is used. A resin having a weight average molecular weight of about 1 million or less is simple to knead before extrusion and has a relatively short heat setting time, which can improve the processability and productivity of manufacturing a porous substrate. Herein, the weight average molecular weight is a value obtained as a polystyrene conversion value by, e.g., gel permeation chromatography, and the units thereof are g/mol. In one example embodiment, the resin may have a weight average molecular weight in a range of from 600,000 to 1,000,000, for example from 500,000 to 800,000 or from 500,000 to 700,000.

The above resin may include any one polymer such as or including at least one of polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or at least one copolymer of two or more of these. For example, the resin may be or include a polyolefin-based resin, for example, a polyethylene-based resin.

In one example, the unstretched film may include about 95 wt % or more, for example, a range of about 95 wt % to about 100 wt %, or about 100 wt %, of a resin having a weight average molecular weight of about 1 million or less. In the above range, the properties of the porous substrate described above may be readily achieved.

In one example, the resin may include about 95 wt % or more, for example, a range of about 95 wt % to about 100 wt %, or about 100 wt %, of a resin having a weight average molecular weight of about 1 million or less. In the above range, the properties of the porous substrate described above may be readily achieved.

As a method of preparing a porous substrate, for example, a polyolefin-based porous substrate, the method may include, for example, a dry film-forming method and a wet film-forming method. As a method of preparing a porous substrate of the example embodiment, a wet film-forming method may be advantageous from the viewpoint of ease of controlling the structure and physical properties of the substrate.

The resin and the film-forming solvent may be melt-kneaded to prepare a resin solution.

The resin may be the same as described above. In addition, the resin solution may include various additives such as, for example, oil, liquid paraffin, an antioxidant, a heat stabilizer, an antistatic agent, an ultraviolet absorber, an antiblocking agent, a filler, a crystal nucleating agent, a crystallization retardant, and the like, within a range that does not impair the effects of the present disclosure.

The resin solution prepared above may be fed from an extruder to a die and extruded into a sheet shape, and the obtained extruded molded body is cooled to manufacture an unstretched film, i.e., a casting film. The unstretched film may be manufactured by feeding a plurality of resin solutions of the same or different compositions from a plurality of extruders to a single die, laminating them therein, and extruding them into a sheet shape.

In one example, the thickness of the unstretched film, i.e., the casting film, may be in a range of about 1500 μm to about 5000 μm, for example about 2000 μm to about 3500 μm. Within the above range, the preparation of the porous substrate may be facilitated by the stretching ratio described below.

Subsequently, the casting film is stretched in at least one uniaxial direction.

The stretching includes multi-stage stretching, and the total stretching ratio is about 150 times or more. In the above range of the total stretching ratio, a porous substrate manufactured from a casting film including a resin having a weight average molecular weight of about 1 million or less can readily satisfy the properties described above (e.g., thickness, puncture strength, air permeability, puncture strength/thickness ratio, thermal shrinkage rate, melt shrinkage rate, and shutdown temperature). For example, the total stretching ratio may be in a range of about 150 to about 300 times, about 163 times or more, or about 163 to about 300 times.

In this specification, the term “total stretching ratio” is a value calculated as an area ratio and is the final area draw ratio. In addition, in the preparation method of the present disclosure, the term “draw ratio” refers to the draw ratio of the casting film immediately before being provided to the next step based on the immediately preceding casting film. In addition, the transverse direction (TD) direction is a direction perpendicular to the machine direction (MD) direction when the film is viewed from a plane. Herein, “MD” may be the machine direction of the unstretched film, i.e., the casting film. The machine direction of the unstretched film, i.e., the casting film, may be the direction in which the unstretched film is manufactured when the unstretched film, i.e., the casting film, is or includes a polyolefin-based resin film, and the polyolefin-based resin is prepared by melt extrusion or solution casting.

In the preparation method, a resin having a weight average molecular weight of about 1 million or less is used, and when a casting film manufactured with the resin is stretched at a total stretching ratio of about 150 times or more in a single-stage stretching, a break may occur. The multi-stage stretching can hinder or prevent the film from breaking when stretching the casting film at the total stretching ratio.

In one example embodiment, the multi-stage stretching may include primary stretching and secondary stretching, and the primary stretching and the secondary stretching may be performed sequentially.

The first and secondary stretching may be either uniaxial stretching or biaxial stretching, and biaxial stretching may be advantageous. In the case of biaxial stretching, either simultaneous biaxial stretching or sequential stretching may be used.

The primary stretching may be performed at a total stretching ratio of at least two times or more, for example, about 2 times to about 5 times. In the above range, there may be an effect of simple process handling during total stretching ratio control and secondary stretching.

In one example embodiment, the primary stretching may be performed by simultaneous biaxial stretching or sequential biaxial stretching of MD uniaxial stretching and

TD uniaxial stretching, or a combination thereof. At this time, the MD uniaxial stretching may have a stretching ratio of about 1.4 times or more, for example, about 1.5 times or more, for example, about 1.5 times to about 3.0 times, and the TD uniaxial stretching may have a stretching ratio of about 1.4 times or more, for example, about 1.5 times or more, for example, about 1.5 times to about 3.0 times.

The secondary stretching may be performed at a total stretching ratio of about 64 times or more, for example, about 64 times to about 75 times. In the above range, a substrate of a separator for a rechargeable lithium battery separator having high strength, a low shutdown temperature, and a low melt shrinkage ratio with improved productivity and processability may be obtained by using a resin having a weight average molecular weight of about 1 million or less.

In one example embodiment, the secondary stretching may be performed by simultaneous biaxial stretching or sequential biaxial stretching of MD uniaxial stretching and TD uniaxial stretching, or a combination thereof. At this time, the MD uniaxial stretching may have a stretching ratio of about 8.0 times or more, for example, about 8.0 times to about 10.0 times, and the TD uniaxial stretching may have a stretching ratio of about 8.0 times or more, for example, about 8.0 times to about 10.0 times.

In one example, the stretching ratio of the primary stretching may be smaller than the stretching ratio of the secondary stretching. When the stretching ratio is too high during the primary stretching of the casting film, the film may break.

In one example, the ratio of the total stretching ratio of the secondary stretching to the total stretching ratio of the primary stretching may be about 16 times or more, for example, about 16 times to about 40 times. In the above range, the properties of the porous substrate may be readily achieved.

The primary stretching and the secondary stretching may each be performed by wet stretching.

In the primary stretching and the secondary stretching, it may be desirable that the stretching temperature is within the range of the crystal dispersion temperature (Tcd) of the resin to Tcd+30° C., for example within the range of the crystal dispersion temperature (Tcd)+5° C. to the crystal dispersion temperature (Tcd)+28° C., and for example within the range of Tcd+10° C. to Tcd+26° C. When the stretching temperature is within the above range, film rupture due to the resin stretching is reduced or suppressed, enabling high-magnification stretching. Herein, the crystal dispersion temperature (Tcd) refers to a value obtained by measuring the temperature characteristics of dynamic viscoelasticity according to ASTM D4065. The stretching temperature may be, for example, about 90° C. or higher and about 130° C. or lower.

Subsequently, the film-forming solvent is removed from the casting film after the stretching. The solvent is removed using a washing solvent. For example, the polyolefin phase of the resin is phase-separated from the film-forming solvent phase, so when the film-forming solvent is removed, a porous membrane is obtained, which is composed of or include fibrils forming a fine three-dimensional network structure and has three-dimensionally irregularly communicating holes (pores). Since the washing solvent and a method for removing the film-forming solvent using the same are known, the description thereof is omitted.

In addition, oil, and the like included in the resin solution may be removed after the stretching.

Subsequently, the microporous film from which the film-forming solvent has been removed is dried by a heat drying method or an air drying method. The drying temperature is for example lower than the crystal dispersion temperature (Tcd) of the resin, and in particular, is for example lower than the Ted by about 5° C. or more. Drying is for example performed until the residual washing solvent becomes about 5 mass % or less based on 100 mass % (dry weight) of the casting film, and for example until the residual washing solvent becomes about 3 mass % or less. When the residual washing solvent is within the above range, the porosity is maintained when the stretching process and heat treatment process of the casting film are performed, and thus the deterioration of permeability is reduced or suppressed.

Subsequently, heat treatment may be performed on the porous substrate after drying. As a heat treatment method, heat setting treatment and/or heat relaxation treatment may be used. Heat setting treatment is a heat treatment that heats the film while maintaining the dimensions thereof in the TD without change. Heat relaxation treatment is treatment that causes the film to thermally shrink in the MD and/or TD during heating. It may be the desirable to perform the heat setting treatment by a tenter or roll method. The heat treatment temperature is for example within the range of the Ted to Tm of the resin.

In one example embodiment, heat setting may be performed while shrinking the film about 5% to about 10% in the TD.

### Porous Substrate

Still another example embodiment includes a porous substrate prepared by the preparation method.

The porous substrate is prepared by the preparation method.

According to one example embodiment, the porous substrate includes a resin, for example, polyethylene, having a weight average molecular weight of about 1 million or less, and the porous substrate may have a thickness of about 10 μm or less, a ratio of puncture strength to thickness of about 75 gf/μm or more, an air permeability of about 120 sec/100 cc or less, a thermal shrinkage rate in each of the MD and TD of about 4.5% or less, a melt shrinkage rate in each of the MD and TD of about-5.0% or more, and a shutdown temperature of about 143° C. or lower.

The content of the porous substrate may be substantially the same as described above. Therefore, the porous substrate may be used as a substrate of a separator for a rechargeable lithium battery to improve the short-circuit defects and impact characteristics of the battery and increase the reliability of the battery.

### Separator for Rechargeable Lithium Battery

Another example embodiment includes a separator for a rechargeable lithium battery including the porous substrate.

In one example, the separator for a rechargeable lithium battery may be the porous substrate alone.

In another example embodiment, the separator for a rechargeable lithium battery may include a porous substrate, and a coating layer including an organic material, an inorganic material, or a combination thereof located on one side, or on both sides, of the porous substrate. The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may be present in a mixed form in one coating layer, or may be present in a laminated form with a coating layer including the organic material and a coating layer including the inorganic material.

### Rechargeable Lithium Battery

According to one example embodiment, the rechargeable lithium battery includes the separator for a rechargeable lithium battery; a positive electrode; and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O₂-D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder attaches the positive electrode active material particles to each other, and also attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., that does not cause an undesirable chemical change in the rechargeable lithium battery), and that conducts electrons, can be used in the battery. Examples of the conductive material may include a carbon-based material such as or including at least one of natural graphite, artificial graphite, carbon black, acetylene black, ketjen black, a carbon fiber, a carbon nanofiber, and carbon nanotube; a metal-based material containing copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., that does not cause an undesirable chemical change in the rechargeable lithium battery), and that conducts electrons, can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone or in combination of two or more solvents.

For example, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like, depending on their shape.

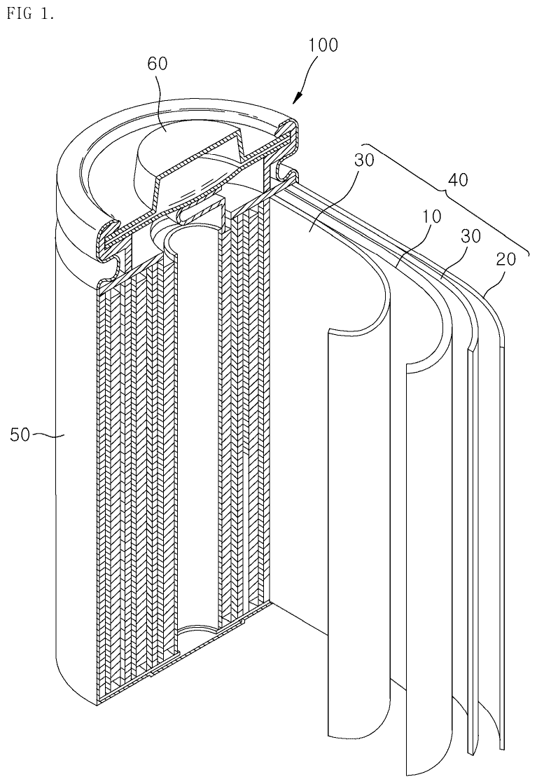

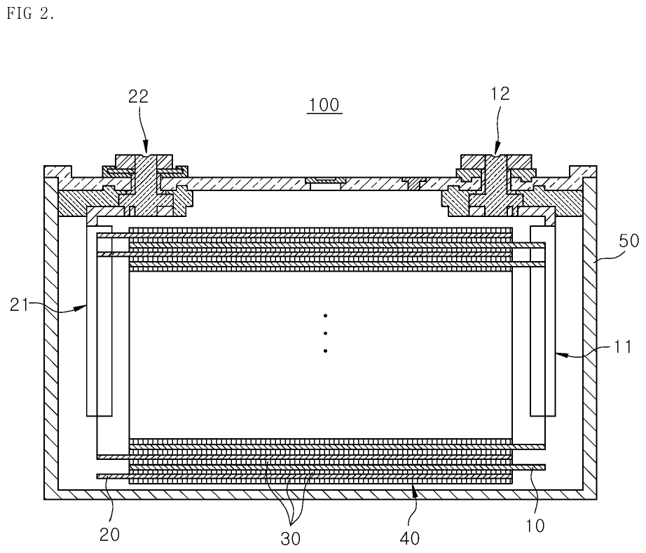

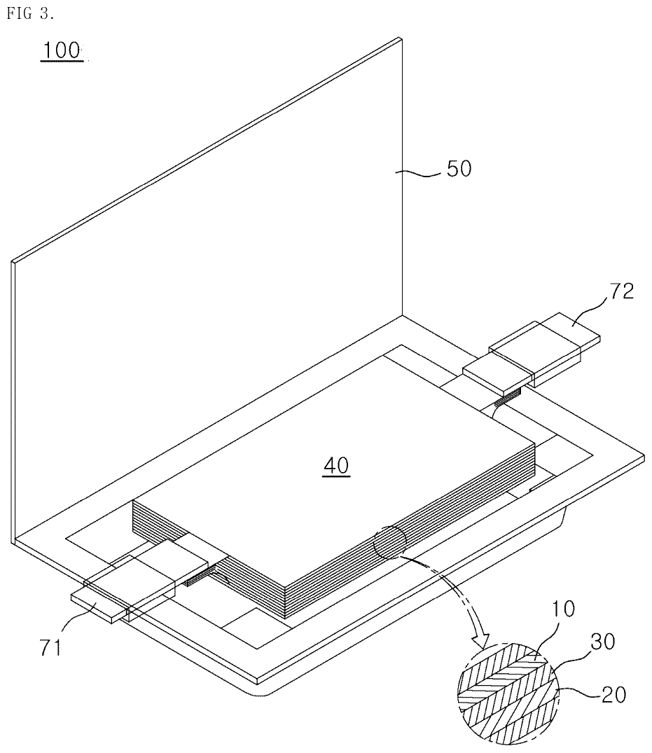

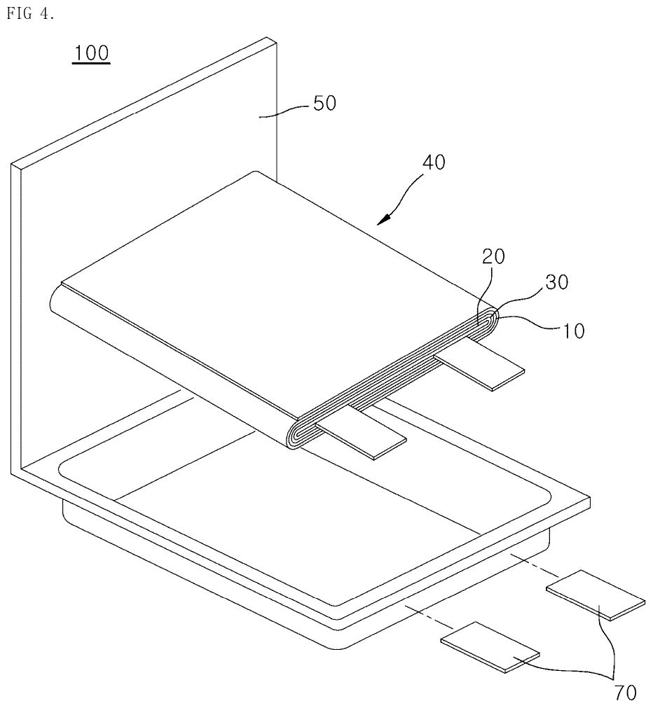

FIGS. 1 to 4 are schematic views illustrating a rechargeable lithium battery according to an example embodiment. FIG. 1 illustrates a cylindrical battery, FIG. 2 illustrates a prismatic battery, and FIGS. 3 and 4 illustrate pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as illustrated in FIG. 1. In FIG. 2, the rechargeable lithium battery 100 may include a positive lead tab 11, a positive terminal 12 connected to the positive lead tab 11, a negative lead tab 21, and a negative terminal 22 connected to the negative lead tab 21. As illustrated in FIGS. 3 and 4, the rechargeable lithium battery 100 may include an electrode tab 70 illustrated in FIG. 4, or, for example, a positive electrode tab 71 and a negative electrode tab 72 illustrated in FIG. 3, the electrode tabs 70/71/72 forming an electrical path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

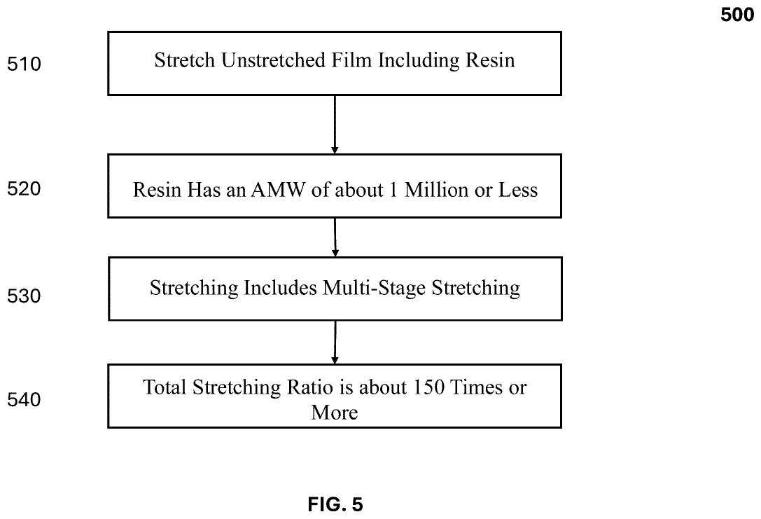

FIG. 5 is a flow chart illustrating a method of preparing a porous substrate of a separator for a rechargeable lithium battery, according to an example embodiment. In FIG. 5, the method 500 includes operation 510, which includes stretching an unstretched film including a resin. For example, at 520 the resin includes a resin having a weight average molecular weight (MW) of about 1 million or less, at 530 the stretching includes multi-stage stretching, and at 540 a total stretching ratio is about 150 times or more.

In an example, the multi-stage stretching includes primary stretching and secondary stretching, and the primary stretching and the secondary stretching are performed sequentially. In a further example, the primary stretching has a total stretching ratio of about 2 times or more, and the secondary stretching has a total stretching ratio of about 64 times or more. In yet another example, the primary stretching is one of simultaneous biaxial stretching, sequential biaxial stretching, or a combination thereof, MD uniaxial stretching has a stretching ratio of about 1.5 times or more, and TD uniaxial stretching has a stretching ratio of about 1.5 times or more. In yet a further example, the secondary stretching is one of simultaneous biaxial stretching, sequential biaxial stretching, or a combination thereof, MD uniaxial stretching has a stretching ratio of about 8.0 times or more, and TD uniaxial stretching has a stretching ratio of about 8.0 times or more.

In other examples, a stretching ratio of the primary stretching is smaller than a stretching ratio of the secondary stretching. In further examples, a ratio of the stretching ratio of the secondary stretching to the stretching ratio of the primary stretching is about 16 times or more. In yet other examples, the unstretched film includes about 95 wt % or more of the resin having a weight average molecular weight (MW) of about 1 million or less. In yet further examples, the resin includes about 95 wt % or more of a resin having an MW of about 1 million or less.

For example, the resin having a weight average molecular weight of about 1 million or less includes a polyolefin-based resin. In another example, the porous substrate has a thickness of about 10 μm or less, a ratio of puncture strength to thickness of about 75 gf/μm or more, an air permeability of about 120 sec/100 cc or less, a thermal shrinkage rate of each in an MD and TD of about 4.5% or less, a melt shrinkage rate in each of the MD and TD of about −5.0% or more, and a shutdown temperature of about 143° C. or lower.

Hereinafter, examples and comparative examples of the present disclosure are described. However, the following examples are given for the purpose of illustration only, and the present disclosure is not limited to the following examples.

### Example 1

28 parts by weight of polyethylene-based resin (weight average molecular weight of 600,000) and 72 parts by weight of liquid paraffin were melt-kneaded using a twin-screw extruder to prepare a polyethylene-based resin-containing solution. The polyethylene-based resin-containing solution was fed from the twin-screw extruder to a T-die and extruded, and then the extruded molded body was cooled while being taken away by a cooling roll to manufacture a casting film.

The casting film was uniaxially stretched at a stretching ratio MD01 in the MD of the casting film by wet stretching at 110° C. to 120° C. using a stretching machine, and then uniaxially stretched in the TD at a stretching ratio TD01 (primary stretching). In the primary stretching, the total stretching ratio was 1.5×1.5=2.25.

Then, the film was uniaxially stretched at a stretching ratio MD02 in the MD of the casting film by wet stretching at 110° C. to 120° C. using a stretching machine, and then uniaxially stretched in the TD at a stretching ratio TD02 (secondary stretching). In the secondary stretching, the total stretching ratio was 8.5×8.5=72.25.

The total stretching ratio was 2.25×72.25=about 163.

Liquid paraffin was extracted and removed from the wet-stretched film using methylene chloride and dried at room temperature to prepare a microporous membrane.

The microporous membrane was heat-set by a tenter method at 125° C. to 130° C. while shrinking 8% in TD to prepare a polyethylene-based porous substrate.

### Examples 2 to 5

Polyethylene-based porous substrates were prepared in the same manner as in Example 1, with a difference that, in Example 1, a polyethylene-based resin having a weight average molecular weight indicated in Table 1 below was used, a casting film having a thickness indicated in Table 1 below was manufactured, and stretching was performed at stretching ratios MD01, TD01, MD02, and TD02 as indicated in Table 1 below in each of the first and secondary stretching.

### Comparative Examples 1 to 11

Polyethylene-based porous substrates was prepared in the same manner as in Example 1, with a difference that, in Example 1, a polyethylene-based resin having a weight average molecular weight indicated in Table 2 below was used, a casting film having a thickness indicated in Table 2 below was manufactured, and stretching was performed at stretching ratios MD01, TD01, MD02, and TD02 as indicated in Table 2 below in each of the first and secondary stretching.

The physical properties of the prepared porous substrate were evaluated and indicated in Tables 1 and 2 below, and the results are shown in Tables 1 and 2 below.

### (1) Puncture Strength (Units: Gf)

Ten specimens were fabricated by cutting the porous substrates manufactured in the examples and comparative examples at ten different points with a width (MD) of 50 mm×length (TD) of 50 mm, the specimens were placed over a 10 cm hole using GATO Tech G5 equipment, and the puncture force was measured while pressing with a 1 mm probe. The puncture strength of each specimen was evaluated three times and the average value of the puncture strength was calculated.

### (2) Air Permeability (Units: Sec/100 cc)

For the porous substrates manufactured in the examples and comparative examples, the air permeability was measured by measuring the time (units: seconds) it takes for 100 cc of air to pass through the separator using a measuring device (EG01-55-1MR, Asahi Seiko). The air permeability was measured twice and the average value was calculated.

Air permeability measurement device setting conditions:

Measurement pressure: 0.5 kg/cm³, cylinder pressure: 2.5 kg/cm³, and setting time: 10 seconds.

### (3) Ratio of Puncture Strength to Thickness (Units: Gf/μm)

The ratio of the measured puncture strength to the thickness of the porous substrate was calculated.

### (4) Thermal Shrinkage Rate (Units: %).

The porous substrates of the examples and comparative examples were cut into a size of 8 cm×8 cm to prepare a specimen. After drawing a 5 cm×5 cm square on the surface of the specimen, the specimen was placed between paper or alumina powder, left in an oven at 150° C. for 1 hour, taken out, the dimensions of the sides of the drawn square were measured, and the shrinkage ratio in each of the MD and TD were calculated. The shrinkage ratio is calculated according to Mathematical Formula 1 below.

$$Mathematical Formula 1$$

$$Shrinkage rate = ( L 0 - L 1 ) / L 0 \times 100$$

L0 is the initial length of the porous substrate, and L1 is the length of the porous substrate after leaving it at 150° C. for 1 hour.

### (5) Melt Shrinkage Rate (Units: %)

The porous substrates of the examples and comparative examples were cut into a size of 1 cm×8 cm to prepare a specimen. Each specimen was mounted on TMA equipment, and the change in length of each specimen was measured while the temperature was increased from room temperature (approximately 20° C.) to approximately 200° C. at a temperature increase rate of 10° C./min under a load of 0.005 N, and the melt shrinkage length compared to the initial length was measured, and then the average value was calculated.

### (6) Shutdown Temperature (Units: ° C.)

While measuring the air permeability of the porous substrates of the examples and comparative examples, the separators were exposed to temperature increase conditions (starting at 30° C. and a temperature increase rate of 5° C./min). At this time, the temperature at which the air permeability (Gurley value) of the separator exceeded 100,000 sec/100 cc was measured. The air permeability was measured using an air permeability measuring instrument (Asahi Seiko, EGO-IT) according to JIS P8117.

TABLE 1

| | | | Examples | | | | |
|---|---|---|---|---|---|---|---|
| | | | 1 | 2 | 3 | 4 | 5 |
| Film- | PE MW | 600 thousand | 100% | 100% | 100% | — | 100% |
| forming | | 1 million | — | — | — | 100% | — |
| process | | 1.5 million | — | — | — | — | — |
| conditions | | 2 million | — | — | — | — | — |
| | Casting film thickness (μm) | | 3000 | 3000 | 4600 | 3000 | 2800 |
| | Primary | MD01 | 1.5 | 1.7 | 2.0 | 1.5 | 1.42 |
| | stretching | TD01 | 1.5 | 1.7 | 2.0 | 1.5 | 1.42 |
| | Secondary | MD02 | 8.5 | 8.8 | 8.0 | 8.5 | 8.6 |
| | stretching | TD02 | 8.5 | 8.8 | 8.0 | 8.5 | 8.7 |
| | Total stretching ratio | | 163 | 224 | 256 | 163 | 150 |
| Porous | Thickness (μm) | | 9.0 | 7.0 | 9.0 | 9.0 | 9.0 |
| substrate | Puncture strength | | 680 | 603 | 715 | 750 | 675 |
| | Air permeability | | 90 | 85 | 87.8 | 90 | 90 |
| | Puncture strength/Thickness | | 75.5 | 86.1 | 79.4 | 83.3 | 75.0 |
| | Thermal shrinkage | MD | 3.0 | 3.5 | 4.5 | 3.0 | 2.8 |
| | rate | TD | 3.0 | 3.5 | 4.5 | 3.0 | 2.9 |
| | Melt shrinkage | MD | −2.5 | −2.0 | −5.0 | −2.7 | −2.4 |
| | rate | TD | −2.5 | −2.0 | −5.0 | −2.7 | −2.5 |

| | | | | | |
|---|---|---|---|---|---|
| Shutdown temperature | 140 | 140 | 140 | 141 | 140 |

TABLE 2

| | | | Comparative Examples | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Film- | PE MW | 600 thousand | 100% | — | — | — | 50% | — | — | — | 100% | — | 100% |
| forming | | 1 million | — | 100% | — | — | — | — | — | — | — | — | — |
| process | | 1.5 million | — | — | 100% | — | 50% | 50% | — | — | — | 100% | — |
| conditions | | 2 million | — | — | — | 100% | — | 50% | 100% | 100% | — | — | — |
| | Casting film thickness (μm) | | 1650 | 2650 | 1980 | 2650 | 1500 | 1500 | 1350 | 1350 | 2050 | 2800 | 2700 |
| | Primary | MD01 | — | — | — | — | — | — | — | — | 1.5 | 1.42 | 1.4 |
| | stretching | TD01 | — | — | — | — | — | — | — | — | 1.5 | 1.42 | 1.4 |
| | Secondary | MD02 | 9.6 | 12 | 10.5 | 12 | 8.0 | 8.0 | 8.0 | 8.0 | 7.0 | 8.6 | 8.6 |
| | stretching | TD02 | 9.6 | 12 | 10.5 | 12 | 10.5 | 10.5 | 9.9 | 9.9 | 7.0 | 8.7 | 8.6 |
| | Total stretching ratio | | 92.16 | 144 | 110.25 | 144 | 84 | 84 | 79.2 | 79.2 | 110.25 | 150.86 | 145 |
| Porous | Thickness (μm) | | 9.0 | 9.0 | 9.0 | 9.0 | 9.0 | 9.0 | 9.2 | 9.2 | 9.1 | 9.0 | 9.0 |
| substrate | Puncture strength | | 450 | 630 | 580 | 700 | 550 | 580 | 600 | 660 | 450 | 702 | 620 |
| | Air permeability | | 120 | 95 | 96 | 95 | 92 | 95 | 95 | 94 | 150 | 98 | 100 |
| | Puncture strength/Thickness | | 50.0 | 70.0 | 64.4 | 77.8 | 61.1 | 64.4 | 65.2 | 71.7 | 50.0 | 78.0 | 68.9 |
| | Thermal | MD | 3.5 | 10.0 | 5.0 | 11.0 | 7.0 | 7.5 | 5.0 | 5.0 | 3.5 | 10.5 | 3.0 |
| | shrinkage | TD | 3.5 | 10.0 | 5.0 | 11.5 | 7.5 | 8.0 | 5.5 | 5.5 | 3.5 | 11.0 | 3.0 |
| | rate | | | | | | | | | | | | |
| | Melt | MD | −3.0 | −21.5 | −14.2 | −25.5 | −7.1 | −10.5 | −12.2 | −15.1 | −3.0 | −22.5 | −2.5 |
| | shrinkage | TD | −3.0 | −21.5 | −15.3 | −26.0 | −7.0 | −10.7 | −12.7 | −15.1 | −3.0 | −23.0 | −2.5 |
| | rate | | | | | | | | | | | | |

| | | | | | | | | | | | |
|---|---|---|---|---|---|---|---|---|---|---|---|
| Shutdown temperature | 146 | 146 | 152 | 144 | 148 | 150 | 150 | 150 | 141 | 154 | 140 |

As shown in Table 1 above, the porous substrates of the examples provide desired or improved mechanical strength and improve a melt shrinkage rate, shutdown temperature and thermal shrinkage rate, which are in a trade-off relationship with the mechanical strength.

On the other hand, as shown in Table 2 above, the porous substrates of the comparative examples did not satisfy all the properties of the porous substrate of the examples.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A method of preparing a porous substrate of a separator for a rechargeable lithium battery, the method comprising:
stretching an unstretched film including a resin,
wherein the resin includes a resin having an average molecular weight (MW) of about 1 million or less,
the stretching includes multi-stage stretching, and
a total stretching ratio is about 150 times or more.

2. The method of claim 1, wherein:
the multi-stage stretching comprises primary stretching and secondary stretching, and
the primary stretching and the secondary stretching are performed sequentially.

3. The method of claim 2, wherein:
the primary stretching has a total stretching ratio of about 2 times or more, and
the secondary stretching has a total stretching ratio of about 64 times or more.

4. The method of claim 2, wherein:
the primary stretching is one of simultaneous biaxial stretching, sequential biaxial stretching, or a combination thereof,
MD uniaxial stretching has a stretching ratio of about 1.5 times or more, and
TD uniaxial stretching has a stretching ratio of about 1.5 times or more.

5. The method of claim 2, wherein:
the secondary stretching is one of simultaneous biaxial stretching, sequential biaxial stretching, or a combination thereof,
MD uniaxial stretching has a stretching ratio of about 8.0 times or more, and
TD uniaxial stretching has a stretching ratio of about 8.0 times or more.

6. The method of claim 2, wherein a stretching ratio of the primary stretching is smaller than a stretching ratio of the secondary stretching.

7. The method of claim 6, wherein a ratio of the stretching ratio of the secondary stretching to the stretching ratio of the primary stretching is about 16 times or more.

8. The method of claim 1, wherein the unstretched film comprises about 95 wt % or more of the resin having a weight average molecular weight (MW) of about 1 million or less.

9. The method of claim 1, wherein the resin includes about 95 wt % or more of a resin having an MW of about 1 million or less.

10. The method of claim 1, wherein the resin having a weight average molecular weight of about 1 million or less comprises a polyolefin-based resin.

11. The method of claim 1, wherein the porous substrate has:
a thickness of about 10 μm or less,
a ratio of puncture strength to thickness of about 75 gf/μm or more,
an air permeability of about 120 sec/100 cc or less,
a thermal shrinkage rate of each in an MD and TD of about 4.5% or less,
a melt shrinkage rate in each of the MD and TD of about-5.0% or more, and
a shutdown temperature of about 143° C. or lower.

12. A porous substrate of a separator for a rechargeable lithium battery, prepared by the preparation method of claim 1.

13. The porous substrate of claim 12, wherein the porous substrate has:
a thickness of about 10 μm or less,
a ratio of puncture strength to thickness of about 75 gf/μm or more,
an air permeability of about 120 sec/100 cc or less,
a thermal shrinkage rate in each of an MD and TD of about 4.5% or less,
a melt shrinkage rate in each of the MD and TD of about −5.0% or more, and
a shutdown temperature of about 143° C. or lower.

14. A separator for a rechargeable lithium battery, the separator comprising the porous substrate of claim 12.

15. A rechargeable lithium battery comprising the separator for a rechargeable lithium battery of claim 14.
